(19) United States
(12) Patent Application Publication
(10) Pub. No.: US 2011/0186529 A1
(43) Pub. Date: Aug. 4, 2011

(54) SOLAR-POWERED WATER PURIFICATION SYSTEM

(76) Inventor: A. Vernon Wright, Newport Beach, CA (US)

(21) Appl. No.: 13/010,676

(22) Filed: Jan. 20, 2011

Related U.S. Application Data
(60) Provisional application No. 61/299,909, filed on Jan. 29, 2010.

(51) Int. Cl. B01D 36/00; B01D 35/26; C02F 1/00

(52) U.S. Cl. 210/808; 210/243; 210/236; 210/143

(57) ABSTRACT

A water purification apparatus enables water purification in the field. An illustrative water purification apparatus can comprise at least one water purification filter and a solar-powered pump configured to pump source water through the at least one water purification filter, producing purified water.

The present application claims priority under 37 C.F.R. §1.78 for the benefit of prior-filed provisional application No. 61/299,909, filed Jan. 29, 2010, which is hereby incorporated by reference in its entirety.

### BACKGROUND

According to the World Health Organization, 1.6 million deaths per year can be attributed to unsafe water, poor sanitation and insufficient hygiene. Governments and individuals around the world are facing international and regional disputes over water, water scarcity and contamination, unsustainable use of groundwater, ecological degradation, and the threat of climate change. The world's water problems lie in the failure to provide even the most basic water services for billions of people and the devastating human health problems associated with that failure.

Availability of potable water for consumption is of growing importance worldwide. While many sources of water exist, water quality is often uncertain. If of poor quality, human health may suffer from the consumption. The ability to utilize found water safely will continue to be of concern to both military and non-military persons. Found water for this disclosure is primarily non-salt water sources (lakes, rivers, ponds, ditches, wells, etc.) although additional filtration known as desalination can be performed so that salt water sources could apply to this invention.

Water can be supplied from a variety of sources such as groundwater (aquifers), surface water (lakes and rivers), conservation, and the ocean via desalination. Found water is usually purified by filtration to make potable and available for drinking and other usage. Water supply continuity, while expected in developed countries, is a severe problem in many developing countries. Water may be available only for a few hours every day or a few days a week. Much of the population of developing countries receives water only intermittently.

### SUMMARY

Embodiments of a water purification apparatus enable water purification in the field. An illustrative water purification apparatus can comprise at least one water purification filter and a solar-powered pump configured to pump source water through the at least one water purification filter, producing purified water.

### BRIEF DESCRIPTION OF THE DRAWINGS

Embodiments of the invention relating to both structure and method of operation may best be understood by referring to the following description and accompanying drawings:

FIGS. 1A, 1B, 1C, 1D, 1E, 1F, and 1G are schematic pictorial diagrams showing an embodiment of a water purification apparatus for water purification in the field;

FIGS. 2A and 2B are schematic pictorial diagrams illustrating embodiments of a water purification unit configured for solar-powered operation; and

FIGS. 3A, 3B, and 3C are schematic flow charts depicting method 300 for purifying water off the grid, using solar power.

### DETAILED DESCRIPTION

Embodiments of a water purification system are disclosed with capability to process any found water into potable water that is safe for human consumption.

Solar-powered water filtration technologies are developed to meet the challenges of the rapidly accelerating water crisis. These water-filtration technologies improve health and safety conditions of areas lacking adequate infrastructure, transmission grids, and direct access to safe water supplies. Such self-sustaining, clean water systems are crucial, for example, in the global fight to provide clean, safe drinking water, reduce the spread of diseases, and improve mortality rates in developing countries and disaster-affected areas.

An embodiment of a water filtration apparatus can produce, for example, up to 25,000 liters (6,500 gallons) of clean, safe drinking water a day, and can operate entirely from the power of the sun, producing potable drinking water which is bacteria, virus, cyst and pathogen free. Larger water volumes, for example up to 400,000 liters or 100,000 gallons, can be filtered using additional solar panels and batteries for energy, larger volume or quantity of filter media tanks to meet water volume demand. Filters can be selected to virtually eliminate arsenic, lead, mercury, and other heavy metals from source water. Various numbers of filter media tanks can be used to treat specific water conditions. Media tanks can be dedicated to remove elements such as fluoride, iron, magnesium, excess Total Dissolved Solids (TDS), or to add elements to the water which lack sufficient volumes of minerals, fluoride, calcium and/or other elements to meet desired balance of minerals. The water filtration apparatus can operate in remote/rural areas with little, if any, infrastructure. No generated power, other than sunshine, is required, only a fresh water source.

Various embodiments and configurations of water purification systems enable improved flexibility and mobility to increase the availability of clean drinking water in commercial/residential/rural/remote areas that lack direct access to clean water and, in some cases, transmission grids.

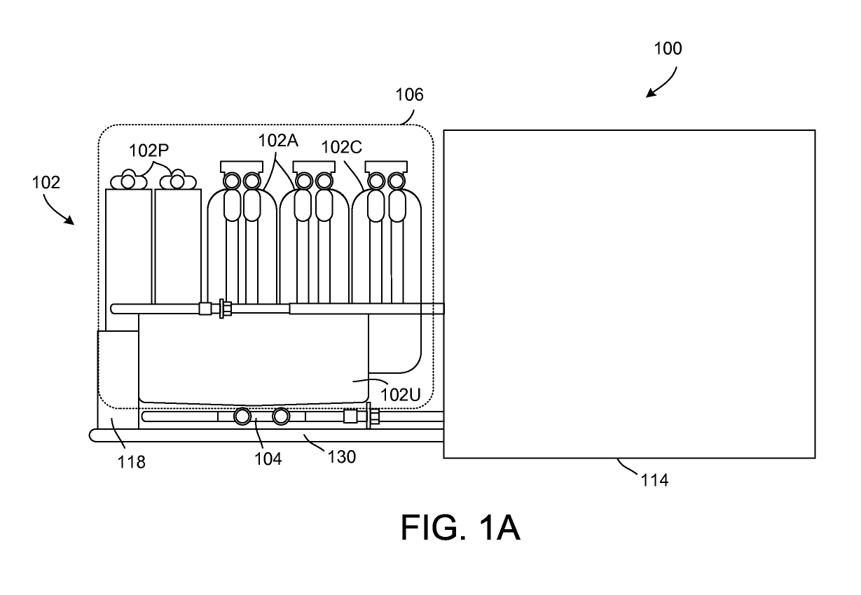

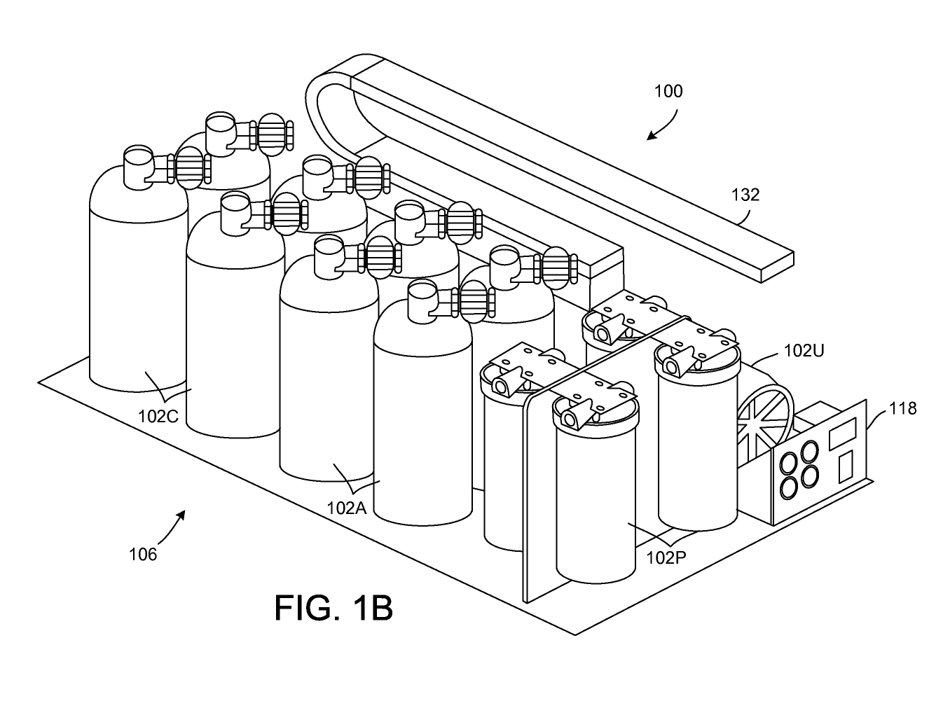

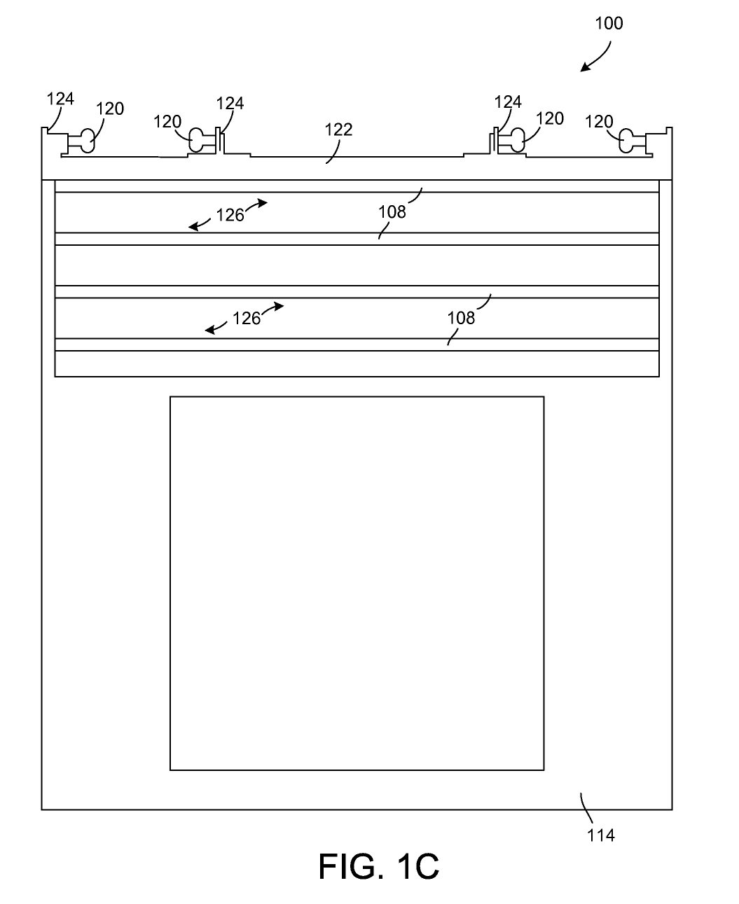

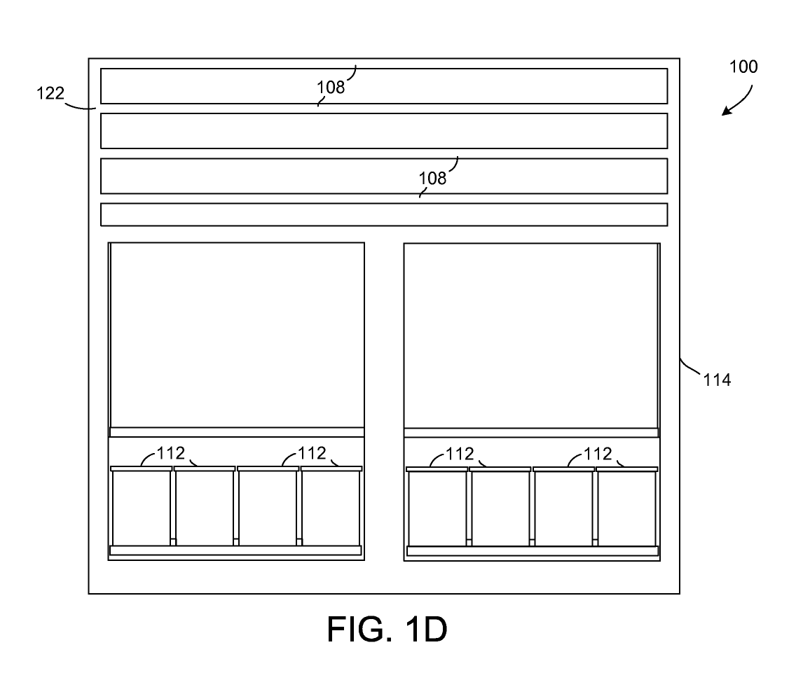

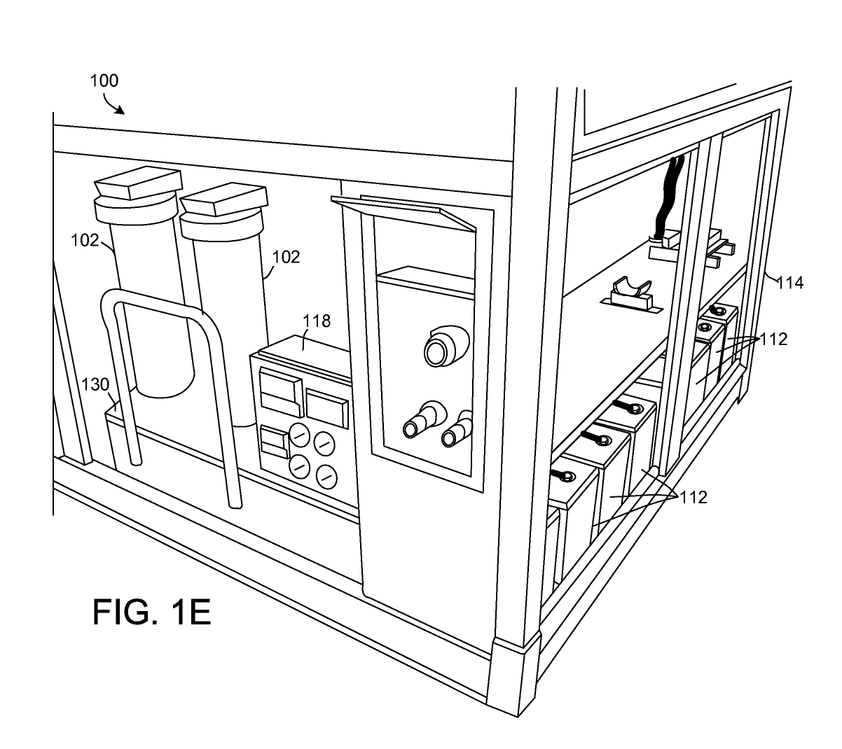

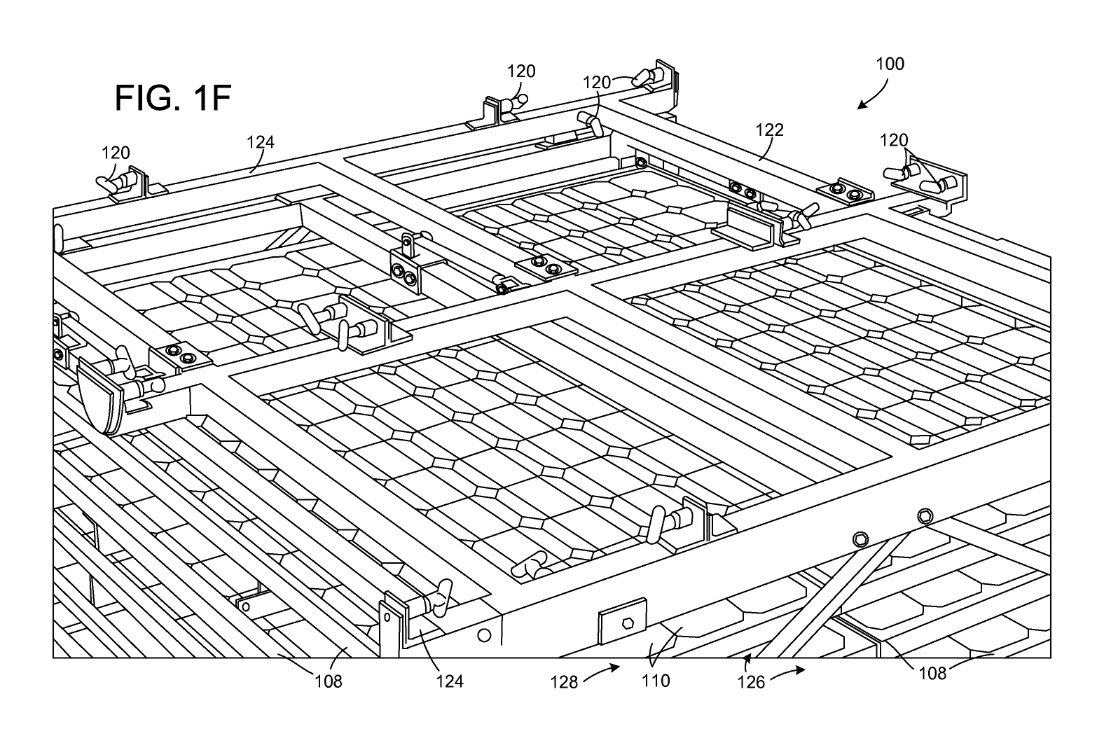

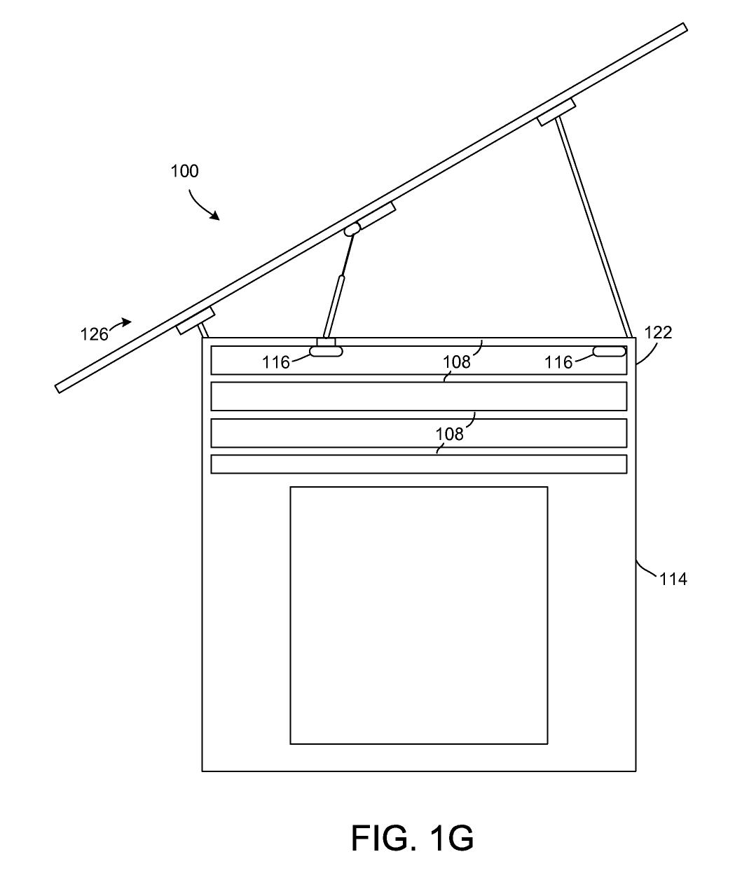

Referring to FIGS. 1A, 1B, 1C, 1D, 1E, 1F, and 1G, schematic pictorial diagrams illustrate an embodiment of a water purification apparatus 100 that enables water purification in the field. An illustrative water purification apparatus 100 can comprise at least one water purification filter 102 and a solar-powered pump 104 configured to pump source water through the one or more water purification filters 102, producing purified water. FIG. 1A shows the filters 102 in an assembled filter subsystem and a controller console 118 on a slide-tray 130 extended out from a cabinet 114. An ultra-filtration filter 102U is arranged on its side in the foreground, securely mounted to a slide-tray 130. Pre-filters 102P are positioned on the far left.

The one or more water purification filters 102 can be configured into an array 106 of filters 102 in an arrangement of multiple filter types. In various embodiments, the array 106 of filters 102 can be selected from: (1) filters characterized by a high-capacity media over a wide range of water conditions, (2) filters characterized by a nanocrystalline structure resulting in fast kinetics enabling smaller diameter vessels and a minimal size system footprint, (3) filters characterized by removal of Arsenic (As) including both As(III) and As(V) across a wide pH range without pretreatment, (4) filters characterized by stable performance during pH fluctuations, and (5) filters characterized by dry, white granules that are easily installed and maintained.

In an illustrative embodiment, the one or more water purification filters 102 can be configured into an array 106 of filters 102 can comprise at least one pre-filter 102P, at least one ultra-filtration filter 102U, at least one heavy metal reduction (arsenic for example) media filter 102A, and at least one activated charcoal filter 102C.

FIG. 1B illustrates the filter subsystem including the filter array 106, mounting bracket 132, and controller module 118. The filter array 106 can include pre-filtration filters 102P. The one or more pre-filters 102P can be configured as turbidity filters with a manifold for even water distribution. The pre-filters remove lead, arsenic, mercury, uranium, cobalt and other heavy metals so only undetectable amounts if any remain in the water. The pre-filter(s) 102P can be configured as a nano-ceramic filter. Nano-ceramic filters are effective pre-filters and can be housed in canisters or tubes, as shown in FIG. 1B. The pre-filters can be removed from the cabinet for cleaning, for example using pressurized water from a hose.

The nano-technology pre-filter(s) 102P can include a pre-filter that removes suspended solids, dirt, dissolved solids, sand, detritus, debris, and related suspended items. The pre-filter 102P also protects and extends the life of the system by preventing large, sharp particles from passing through a filtering membrane. The nano-technology pre-filter can remove particles or other elements to 0.02 microns or less if desired to 0.015 or 0.01 microns.

The filter array 106 can also include one or more ultra-filtration filters 102U. One example of a suitable ultra-filtration filter is a Homespring Water Purification System, which is manufactured and sold by General Electric (GE) or New York, which contains a fiber media, as shown in FIG. 1B. The ultra-filtration filter performs filtration by significant physically blocking of pathogens including bacteria, viruses, cysts, turbidity, particulates, and fluoride from water. In an example configuration, pore size on the surface of the ultra-filter membrane is approximately 0.02 microns, a size that may help filtration of particulate iron and reduce taste and odor caused by sulfur. Ultra-filtration membranes reduce the permissible flow through micron size of elements to 0.015 microns or even 0.01 microns, as desired. The number of ultra-filtration media tanks can be selected to address particular water conditions. The media and membrane characteristics can be selected for removal of particular elements (metals, solids) and/or can be selected to add elements to the water to attain a desired mineral balance.

Water pressure generated by the solar-powered pump forces the unfiltered source water into the pre-filter housing positioned prior to the filter array 106 in the flow pathway. Larger particulates and chlorine, which are filtered by a carbon pre-filter 102P, are removed as the water passes from outside to inside of the ultra-filtration filter 102U. In a membrane chamber of the ultra-filtration filter 102U, water passes through the membrane pores from outside to inside a hollow fiber membrane, leaving filtered particles including bacteria, parasites, and some viruses. The unit enables the operator to determine a desired interval for back-flushing captured bacteria, viruses, cysts, and pathogens to a disposal stream through an automatic pressure gauge or timing device.

In various implementations, the filter(s) 102 can include one or more filters 102A wherein filtering media is heavy metal reduction media, for example As500 Titanium-based media from Dow Chemical of Midland, Mich., MetSorb™ from Graver Technologies of Glasgow, DE, and/or ARSENICOUT™ media from DynGlobal of Newport Beach, CA. In an example embodiment, a heavy metal reduction filter has a filter media comprising titanium dioxide (80-90% by volume), water (0.1-10%), silica (1.0-10%), anhydrous calcium sulfate (0.1-18%), sulfuric acid disodium salt (0.1-30%), iron (III) oxide (less than 1.0%), diammonium sulfate (less than 10%), and magnesium sulfate (0.1-30%). Heavy metal reduction media has a titanium oxide-based, nanocrystalline structure that is characterized by fast kinetics and high capacity, enabling water treatment for usage in relatively small water holding vessels, higher flow rates, and a relatively small system footprint. Heavy metal reduction media removes both As (III) and As (V) without pretreatment, under most naturally occurring pH water conditions. Heavy metal reduction media eliminates a requirement for regeneration, avoiding difficulties and cost inherent in chemical storage and disposal of arsenic-laden waste regenerant streams. Heavy metal reduction media has a strong affinity for arsenic and maintains fixation on the arsenic that has been adsorbed making media disposal easier and safer.

In an example embodiment, high-capacity ARSENICOUT™ media can be used which is particularly useful for implementation in a non-regenerable single-use product. Eliminating regeneration avoids the inconvenience and cost of chemical storage and usage while eliminating waste stream disposal concerns. The ARSENICOUT media has a strong affinity for arsenic also enabling the media to maintain a strong hold on the removed arsenic, and improved facility and safety in disposal. The ARSENICOUT media also features a longer useful life than traditional adsorbent media, for a more productive and cost-advantaged operation.

The filter array 106 can also include activated carbon filters 102C. The filter array 106 in the illustrative solar-powered water purification system 100 includes two activated-carbon post-filters 102C, with a manifold to distribute water evenly. The post-filters can be housed in canisters or tubes, as shown in FIG. 1B, and contain activated carbon, for example in the form of burnt coconut shells. One manufacturer and dealer of activated-carbon filters is Nimbus in Murietta, California.

The array 106 of filters 102 forms a scalable water filtration system for supplying highly purified water, removing heavy metals such as arsenic and lead as well as bacteria, cysts, viruses, and pathogens.

The solar-powered pump 104 can be configured to generate a hydraulic pressure that drives source water through the array 106 of water purification filters 102. For example, the solar-powered pump 104 of the illustrative embodiment generates a suitable minimum water pressure for operating the filter array 106, for example 30 psi or less.

The solar-powered pump 104 is generally used to draw unpurified water from a water source. A hose is placed at the water source and used to channel the water from the source to the purification unit 100. A host of any suitable size may be used. Typically a hose at least approximately 70 feet can be used to reach water sources in wells or at locations where the unit itself may not be able to be stabilized for use.

The water purification apparatus 100 can further comprise one or more controllers 118 that perform various control operations. A controller 118 can be used to monitor and control levels of Total Dissolved Solids (TDS) in water. The controller 118 water purification apparatus 100 can implement a maximum set point to maintain a limit of allowed TDS in the water. If the TDS level rises to the set point, the controller 118 can actuate an alarm or warning light, or can control operation of the pump 104 or various valves.

In the illustrative embodiment, the controller 118 can include several components including a DPF model ratemeter/totalizer from Omega Engineering, Inc. of Stamford, Conn.; and a PS-100 TDS controller from HM Digital, Inc. of Culver City, Calif. The controller components ensure sufficient energy is supplied to run the pump 104.

Electrical wires for supplying power and control connect the batteries 112, the solar panels 108, the controller 118, the pump 104, meters, inverters, and the like.

The water purification apparatus 100 can further comprise one or more solar panels 108 and one or more batteries 112. FIG. 1C shows an arrangement of solar panels 108 mounted on the cabinet 114, including several solar modules 126 with hardware 120, located above the solar rack 122 which are used to secure the solar modules 126 to the rack 122. The solar panel(s) 108 can be configured as an interconnected array of photovoltaic solar cells 110 operative to convert photons from the sun directly to electrical energy via photoelectric effect. The one or more batteries 112 can be coupled to the solar panel(s) 108 and configured for recharging via solar-powered electrical energy and powering the solar-powered pump 104 in absence of electric grid power and consistent sun exposure.

FIGS. 1D and 1E depict the arrangement of batteries 112 in an illustrative solar-powered water purification apparatus 100. FIG. 1D shows the cabinet 114 with the front panel removed, showing the batteries 112 secured on the bottom, the middle compartment which can be used to store a hose, and the solar panels 108 stored in racks 122 on the top. FIG. 1E is a front/side perspective view showing the filter subsystem 106 and batteries 112 housed in the cabinet 114.

In an example embodiment, the batteries 112 can be configured with valve-regulated lead-acid (VRLA) technology, either gelled electrolyte or absorbed glass mat (AGM) batteries. Other embodiments can be implemented using flooded lead-acid technology. VRLA technology batteries 112 are useful in the solar-powered water purification apparatus 100 given properties of total freedom from maintenance, air transportability, spillproof and leakproof characteristics, absence of corrosion, and the like, which facilitate transport to locations of difficult and limited accessibility in military and emergency conditions.

Various embodiments of the water purification system 100 can incorporate a selected number of batteries 112. For example, one embodiment can include sixteen 12-volt solar batteries from Trojan Battery Company of Santa Fe Springs, California. Electrical energy generated from solar power recharges the batteries 112. The batteries 112 power the water pump 104. In the illustrative embodiment shown in FIGS. 1D and 1E, the batteries 112 are stored and secured, eight to each side of the cabinet 114 to balance weight of the unit for stability. The batteries 112 are stored in slots, within rails in the cabinet 114.

FIGS. 1F and 1G depict the solar system in more detail. FIG. 1F illustrates a top perspective view of the solar panels 108 mounted in the solar racks 122 overlying the cabinet of the water purification apparatus 100. The solar panels 108 can be raised to a selected angle deemed appropriate for conditions, for example using a voltage meter to enable determination of amount of energy being harnessed. FIG. 1G shows the solar panels 108 positioned at an angle to increase the amount of solar energy on the solar cells 110.

The water purification apparatus 100 can be implemented with any desired suitable type and number of solar panels. For example, in one illustrative embodiment, 8-12 Mono-Crystalline Solar Panels from Suntech Power Holdings Co., Ltd. of Wuxi, China.

The water purification apparatus 100 can further comprise a controller 118 operative as a solar system controller which can control, for example, operating mode. In an example embodiment, the solar system controller 118 can control solar battery charging, load control, and diversion charge control. In solar battery charging, energy output of the solar array 128 is used for recharging the system battery. The controller 118 manages the charging process for efficiency and to maximize battery life. Charging includes a bulk charging stage, pulse width modulation absorption, float, and equalization. When operating in load control mode, the controller 118 powers loads from the battery and protects the battery 112 from over-discharge with a current-compensated low voltage load disconnect. In diversion charge control mode, the controller 118 can manage battery charging by diverting energy from the battery 112 to a dedicated diversion load.

The controller 118 components can further include rate meters and/or totalizers. A rate meter can be used to monitor and, in come configurations, display water flow rate and total water amounts. Water flow readings can be used for controlling pumps, valves, and the like in the water flow path of the water purification apparatus 100.

The controller 118 can also include a filter control functionality to control water flow to selected filters 102. In some embodiments, the filter controller 118 can monitor and control water pressure applied to a filter 102.

The controller 118 can further include other components for power conversion and battery charging. A power converter can convert a nominal AC voltage to DC. The converter operates as a power supply with controlled regulation, enabling operating at an appropriate nominal DC load up to the converter's rated output current. As a battery charger, the converter maintains the battery delivering a full-rated current when the battery falls sufficiently low. Voltage is set to deliver maximum current for a period of time that minimizes undue stress to the battery caused by heating of battery cells, ensuring longest possible battery life. Over time, as the battery nears full capacity, the converter float-charges the battery to prevent self-discharge of the cells.

In an illustrative embodiment, a power converter is selected which has capability to convert 1200 watts (for 8 solar panels) or 1750 watts (for 10 solar panels). A suitable converter is a DLS Series converter from IOTA Engineering of Tucson, Ariz.

Control components 118 can further include a sine-wave inverter for power conversion for supplying a clean, regulated sine-wave output over a wide DC input range with low total distortion and harmonic distortion, and maintaining spectral purity over the inverter's entire operating envelope, including non-linear and reactive loads.

The water purification apparatus 100 can further comprise a cabinet 114 configured for holding the filter(s) 102 and the solar-powered pump 104 in an arrangement that supports the solar panel(s) 108 during operation.

The cabinet 114 can be configured for holding the filter(s) 102 and the solar-powered pump 104 in an arrangement that contains components in a cuboid hexahedron arrangement sized for pallet-loading for efficient transport, facilitating installation and rapid deployment. The arrangement can be stored horizontally and, in some embodiments, stacked to facilitate transport of numerous units via ship, automotive, train, or air carrier. The cabinet 114 can further be configured for holding the filter(s) 102 and the solar-powered pump 104 in an arrangement for usage in disaster relief, extreme conditions, and remote areas.

In an illustrative embodiment, the cabinet 114 can be configured as a generally box-shaped unit constructed of metal or durable plastic and used to house components during transport and, for some components, during use. The cabinet 114 can also support the solar panels 108 during use, and forms the support base of the entire system 100. Sufficient latching or locking components 120 are included to ensure stability of the cabinet 114. Various compartments are sized to fit various components during storage and/or use. Racks 122 and/or rails 124 are included to hold and protect the solar panels 108 during transport and storage. The racks 122 can be pulled out along the rails 124 to access the solar panels 108 for removal and installation. Some components can be fixedly mounted inside or to the cabinet 114 with others attachable to the cabinet 114 via ports, valves, clamps, and the like. In an illustrative arrangement, the cabinet 114 can be sized to fit comfortably on a 463L pallet, and may even have guide rails on the bottom to enable easy loading by a forklift when the entire unit is on the ground. An illustrative particular embodiment of the cabinet 114 can have dimensions of about 6 feet wide by 6 feet long by 5 feet high in a configuration that facilitates loading of multiple units in a carrier for emergency or military usage. The cabinet 114 of the illustrative embodiment is further configured to include stabilizer pull-out out-riggers to provide stability in difficult set-up environments such as terrain with obstructions, irregular ground, and the like. The stabilizer out-riggers create additional support when the pull-out filter pack tray is withdrawn from the cabinet 114 for inspection or service.

In the illustrative embodiment, the cabinet 114 contains components in a horizontal arrangement to increase flexibility and mobility, and can be sized for pallet-loading for efficient transport, facilitating installation and rapid deployment. For example, systems can be formed to enable unloading and operation in the field within about fifteen minutes.

The cabinet 114 can also have a hinged top, connected to walls of the cabinet 114 by spring cylinders, shock absorbers, and the like to allow pivoting of the solar panel array 128 once the solar panels are installed thereon. The top can be configured as an array 128 to enable the solar panels 108 to be inserted securely into respective channels/locations.

In some configurations, the water purification apparatus 100 can further comprise one or more solar panels 108 configured as an interconnected array of photovoltaic solar cells 110 which are operative to convert photons from the sun directly to electrical energy via photoelectric effect, and a tracking motor 116 coupled to the solar panel(s) 110. A controller 118 coupled to the tracking motor 116 is configured to dynamically position the solar panel(s) 110 to track motion of the sun.

The water pump 104 creates pressure for running the water through the purification filters 102. The solar-powered water purification apparatus 100 can be configured with a limited number of moving parts for increased reliability. For example, in some configurations the water pump 104 can be the single moving part. In other embodiments, the solar panels 108 can be dynamically tracking with the solar panels 108 and tracking motor 116 also being moving parts. The water pump 104 uses electrical energy sourced by the solar panels 108 to draw in water from the water source, which can be a well, a stream, or any other source.

The water purification apparatus 100 can be implemented with any desired suitable type, size, and configuration of a pump, or multiple pumps, if desired. For example, in one illustrative embodiment, Solar Water Pump System (DS600HR/C) from Bernt Lorentz GmbH & Co. of Hamburg, Germany works well.

The solar panels 108 can be raised to a selected appropriate angle, for example using a voltage meter to enable determination of amount of energy being harnessed. The solar panels 108 are a packaged interconnected array of photovoltaic solar cells 110 and use light energy (photons) from the sun to generate electricity via the photovoltaic effect, converting sunlight directly to electricity through the use of the solar panels 108. Light causes electrons to move from a top layer of a solar cell 110 into “holes” in an underlying layer. Electric current flows when a circuit is completed between the top and bottom layers of the solar cell 110. Each cell 110 generates a characteristic voltage, for example about a half volt for some cells, so that, as sunlight varies, the current varies while the voltage remains substantially constant. The photovoltaic cells 110 are connected in series to attain a desired voltage, and sealed under glass to form a module 126. Multiple modules are assembled into a cell array 128.

Several solar panels 108 can be combined in a scalable fashion to generate various selected amounts of electrical energy.

In operation, the water purification system 100 can be positioned at the location of or near a water source. A hose is placed in the water source for pumping into a water pathway within the system by the pump 104. Upon activation, the pump 104 drives the water through the hose which is connected to the purification system 100 housed within the cabinet 114. The water first passes through the turbidity pre-filters via a manifold to disperse the water relatively evenly among the multiple pre-filters 102U, then through the ultrafiltration filter 102U, then through the heavy metal reduction media containers 102A (typically through a manifold), then through the activated carbon post-filters 102C (typically through a manifold), then through the output port which may be a small hose or nozzle.

In an example embodiment, the system can be sized and configured to purify up to 6500 gallons of water per day with only solar power, and up to 13,000 gallons or higher volumes of water per day on solar power grid/generator power.

Form of the water purification apparatus 100, specifically the form and durability of the cabinet 114, the arrangement of the solar panels 108 on racks 122 and rails 124 mounted on the cabinet 114 facilitate the capacity for rapid deployment to earthquake, tsunami, hurricane, flood, and other natural disaster locations. The water purification apparatus 100 is particularly suited for usage in countries affected by civil unrest, dislocation and armed conflict, as well as drought-starved regions and those plagued by waterborne diseases such as diarrhea, cholera and polio.

The illustrative water purification apparatus 100 is a self-sufficient unit that can operate 24 hours a day without the need of grid power or even consistent sun exposure, supplying potable water to thousands in both urban and rural environments with little to no ongoing maintenance.

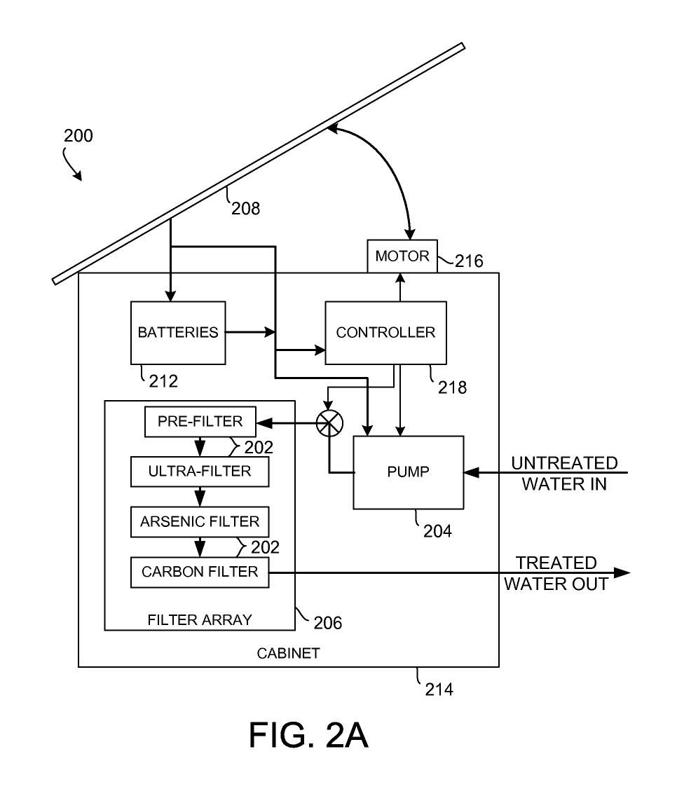

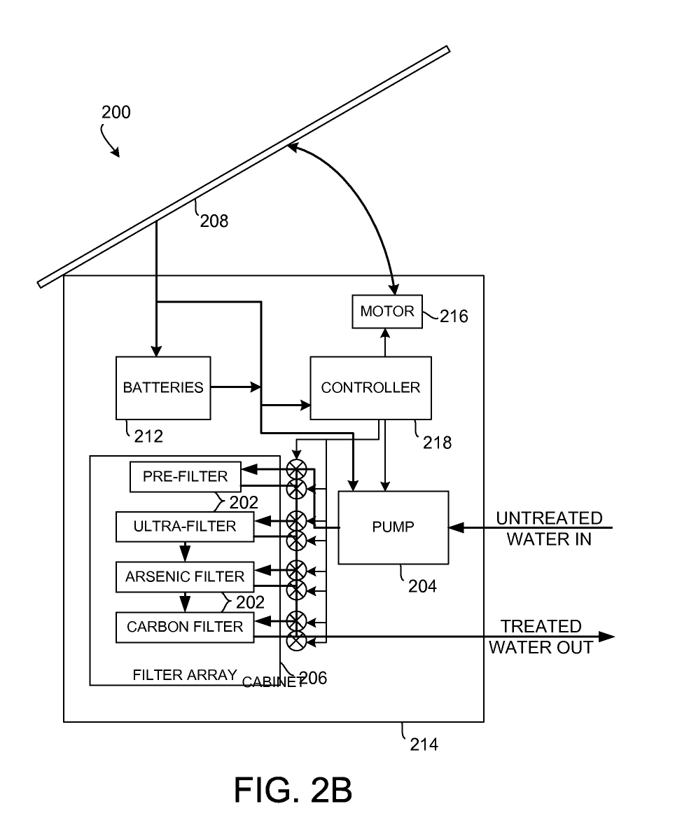

Referring to FIGS. 2A and 2B, schematic pictorial diagrams illustrate embodiments of a water purification unit 200 configured for solar-powered operation which can be used, for example, in extreme conditions, in remote areas where power is compromised or unavailable, and for disaster relief, even for large scale disasters. The illustrative water purification unit 200 can comprise an array 206 of filters 202 in an arrangement of a plurality of filter types, and at least one solar panel 208 configured as an interconnected array of photovoltaic solar cells. The water purification unit 200 can further comprise a pump 204 powered by the one or more solar panels 208 configured to pump water at a pressure for passing the water through the array 206 of filters 202.

The water purification unit 200 can further comprise one or more batteries 212 coupled to the one or more solar panels 208 configured for recharging via solar-powered electrical energy and powering the pump 204 in absence of electric grid power and consistent sun exposure.

The filter array 206 can comprise, for example, filters 202 selected from among pre-filters, ultra-filtration filters, heavy metal reduction media filters, and activated charcoal filters, and others.

The water purification unit 200 can further comprise a cabinet 214 configured for holding the filter array 206 and the pump 204 in an arrangement that contains components in a horizontal arrangement sized for pallet-loading for efficient transport, facilitating installation and rapid deployment.

In some embodiments, the solar-powered pump 204 can be passive and manually positioned.

In other arrangements, an active (automatic) system 200 can be configured with solar tracking—tilting the solar panel array to follow the sun as it moves through the day. The active system includes a motor system 216 for moving the array and a controller 218 for controlling the motor 216. The water purification unit 200 can be implemented with a tracking motor 216 coupled to the solar panel(s) 208, and a controller 218 coupled to the tracking motor 216 configured to dynamically position the solar panel(s) 208 to track sun motion.

FIG. 2B illustrates an embodiment which enables the controller 218 to control valves to each of the sets of filters 202, enabling precise selection of filters, for example as determined by water characteristics.

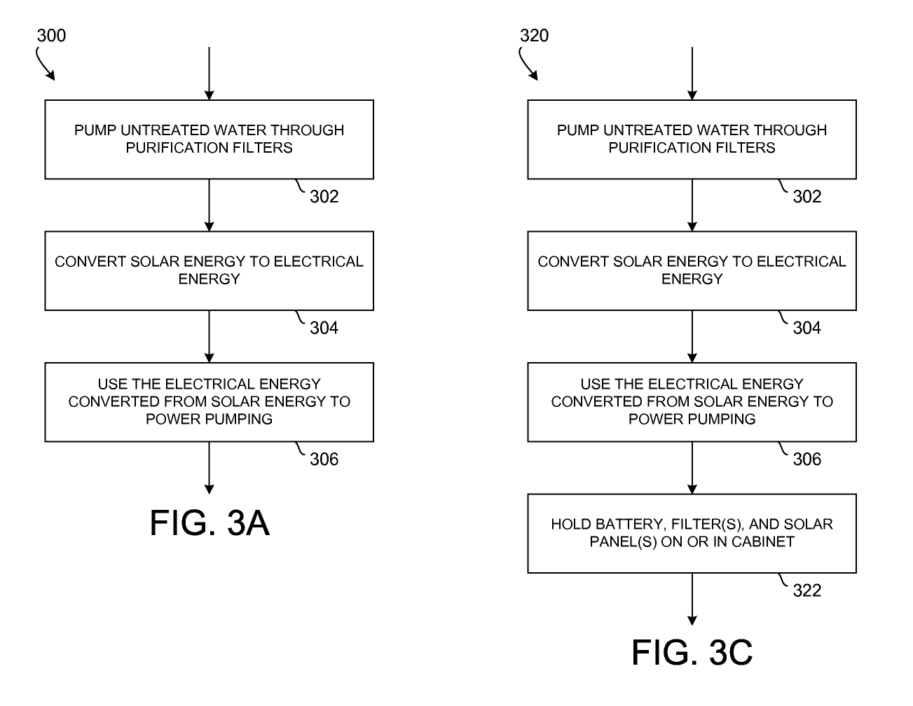

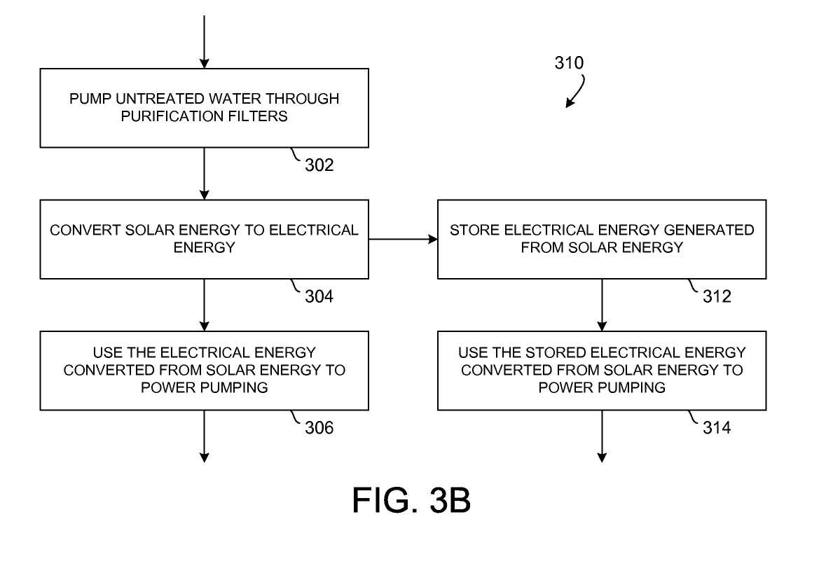

Referring to FIGS. 3A, 3B, and 3C, schematic flow charts depict methods 300 for purifying water off the grid, using solar power. The water purification method 300 illustrated in FIG. 3A comprises pumping 302 untreated water through one or more water purification filters. Solar energy is converted 304 to electrical energy, and the electrical energy converted from solar energy powers 306 pumping of the water.

In some embodiments, for example as shown in FIG. 3B, a method 310 can further comprise storing 312 the electrical energy generated from the solar energy, and powering 314 the pumping of water using the stored electrical energy.

Referring to FIG. 3C, in some embodiments a method 320 can further comprise holding 322 a battery or other means for pumping the untreated water, a solar panel or other means for converting the solar energy to electrical energy, and the one or more water purification filters inside or attached to a cabinet. The cabinet can be arranged in a cuboid hexahedron form which is sized for pallet-loading for efficient transport, facilitating installation and rapid deployment.

Solar-powered water purification is highly useful for many applications such as in the developing world and military situations. Various embodiments of the system can be used to address the many water districts have Arsenic levels above the Environmental Protection Agency (EPA) limit of 10 ppb, and the very poor quality of water in the Western United States (AZ, CO, UT, NM, NV) reservation sites that lack infrastructure and power grid. The water purification system is also useful for disaster relief (Homeland Security and FEMA) by National Guard Units for disaster response, clean-up of coal ash pond spills, hurricane and flood response, earthquake response, terror attacks on water supplies, and the like.

Embodiments of the solar-powered water purification system remove arsenic, lead, mercury and other heavy metals from source water. The pump facilitates operation in adverse conditions, for example operation under high turbidity conditions in remote villages by drawing water from bore holes at least 30 meters deep. The battery pack enables the unit to temporarily operate without sunlight, for example in the illustrative embodiment for up to five (5) days without direct sunlight.

Terms “substantially”, “essentially”, or “approximately”, that may be used herein, relate to an industry-accepted variability to the corresponding term. Such an industry-accepted variability ranges from less than one percent to twenty percent and corresponds to, but is not limited to, materials, shapes, sizes, functionality, values, process variations, and the like. The term “coupled”, as may be used herein, includes direct coupling and indirect coupling via another component or element where, for indirect coupling, the intervening component or element does not modify the operation. Inferred coupling, for example where one element is coupled to another element by inference, includes direct and indirect coupling between two elements in the same manner as “coupled”.

The illustrative pictorial diagrams depict structures and process actions in a manufacturing process. Although the particular examples illustrate specific structures and process acts, many alternative implementations are possible and commonly made by simple design choice. Manufacturing actions may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, shapes, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims.

What is claimed is:

1. A water purification apparatus comprising:
at least one water purification filter; and
a solar-powered pump configured to pump source water through the at least one water purification filter, producing purified water.

2. The apparatus according to claim 1 wherein the at least one water purification filter comprises:
an array of filters in an arrangement of multiple filter types, the array of filters selected from a group consisting of at least one filter characterized by a high-capacity media over a wide range of water conditions, at least one filter characterized by a nanocrystalline structure resulting in fast kinetics enabling smaller diameter vessels and a minimal size system footprint, at least one filter characterized by removal of Arsenic (As) including both As(III) and As(V) across a wide pH range without pretreatment, at least one filter characterized by stable performance during pH fluctuations, at least one filter characterized by dry, white granules that are easily installed and maintained.

3. The apparatus according to claim 1 wherein the at least one water purification filter comprises:
a filter array comprising at least one pre-filter, at least one ultra-filtration filter, at least one heavy metal reduction media filter, and at least one activated charcoal filter.

4. The apparatus according to claim 1 wherein the at least one water purification filter comprises:
at least one pre-filter is configured as turbidity filters with a manifold for even water distribution.

5. The apparatus according to claim 1 wherein the at least one water purification filter comprises:
at least one pre-filter configured as a nano-ceramic filter.

6. The apparatus according to claim 1 wherein the at least one water purification filter comprises:
at least one filter comprising heavy metal reduction media.

7. The apparatus according to claim 1 further comprising:
an array of water purification filters in an arrangement of multiple filter types; and
the solar-powered pump configured to generate a hydraulic pressure that drives source water through the array of water purification filters.

8. The apparatus according to claim 1 further comprising:
at least one solar panel configured as an interconnected array of photovoltaic solar cells operative to convert photons from the sun directly to electrical energy via photoelectric effect; and
at least one battery coupled to the at least one solar panel configured for recharging via solar-powered electrical energy and powering the solar-powered pump in absence of electric grid power and consistent sun exposure.

9. The apparatus according to claim 1 further comprising:
at least one solar panel configured as an interconnected array of photovoltaic solar cells operative to convert photons from the sun directly to electrical energy via photoelectric effect; and
a cabinet configured for holding the at least one filter and the solar-powered pump in an arrangement that supports the at least one solar panel during operation.

10. The apparatus according to claim 1 further comprising:
a cabinet configured for holding the at least one filter and the solar-powered pump in an arrangement that contains components in a cuboid hexahedron arrangement sized for pallet-loading for efficient transport, facilitating installation and rapid deployment.

11. The apparatus according to claim 1 further comprising:
a cabinet configured for holding the at least one filter and the solar-powered pump in an arrangement for usage in disaster relief, extreme conditions, and remote areas;
a slide-tray slidably attached to the cabinet and configured for holding the at least one filter; and
stabilizer out-riggers coupled to the cabinet and configured for increased stability when the slide-tray is withdrawn from the cabinet.

12. The apparatus according to claim 1 further comprising:
at least one solar panel configured as an interconnected array of photovoltaic solar cells operative to convert photons from the sun directly to electrical energy via photoelectric effect; and
a tracking motor coupled to the at least one solar panel; and
a controller coupled to the tracking motor configured to dynamically position the at least one solar panel to track sun motion.

13. A water purification unit comprising:
an array of filters in an arrangement of a plurality of filter types;
at least one solar panel configured as an interconnected array of photovoltaic solar cells; and
a pump powered by the at least one solar panel configured to pump water at a pressure for passing the water through the array of filters.

14. The unit according to claim 13 further comprising:
at least one battery coupled to the at least one solar panel configured for recharging via solar-powered electrical energy and powering the pump in absence of electric grid power and consistent sun exposure.

15. The unit according to claim 13 wherein the array of filters comprises:
a filter array comprising filters selected from among a group consisting of pre-filters, ultra-filtration filters, heavy metal reduction media filters, and activated charcoal filters.

16. The unit according to claim 13 further comprising:
a cabinet configured for holding the filter array and the pump in an arrangement that contains components in a cuboid hexahedron arrangement sized for pallet-loading for efficient transport, facilitating installation and rapid deployment;
a slide-tray slidably attached to the cabinet and configured for holding the at least one filter; and
stabilizer out-riggers coupled to the cabinet and configured for increased stability when the slide-tray is withdrawn from the cabinet.

17. The unit according to claim 13 further comprising:
a tracking motor coupled to the at least one solar panel; and
a controller coupled to the tracking motor configured to dynamically position the at least one solar panel to track sun motion.

18. A method of purifying water comprising:
pumping untreated water through at least one water purification filter;
converting solar energy to electrical energy;
powering the pumping of water using the electrical energy converted from solar energy.

19. The method according to claim 18 further comprising:
storing the electrical energy generated from the solar energy; and
powering the pumping of water using the stored electrical energy.

20. The method according to claim 18 further comprising:
holding a means for pumping the untreated water, a means for converting the solar energy to electrical energy, and the at least one water purification filter to a cabinet in a cuboid hexahedron arrangement sized for pallet-loading for efficient transport, facilitating installation and rapid deployment.
